(19) United States
(12) Patent Application Publication
(10) Pub. No.: US 2026/0106695 A1
(43) Pub. Date: Apr. 16, 2026

(54) SYSTEMS AND METHODS FOR CHANNEL CODING USING AN AUTOENCODER TRAINED FOR BLOCK ERROR REDUCTION

(71) Applicant: Samsung Electronics Co., Ltd., Suwon-si (KR)

(72) Inventors: Karl Chahine, Austin, TX (US); Mohamed Vahid Jamali, Nashville, TN (US); Hamid Saber, San Diego, CA (US); Jung Hyun Bae, San Diego, CA (US)

(21) Appl. No.: 19/340,826

(22) Filed: Sep. 25, 2025

Related U.S. Application Data
(60) Provisional application No. 63/705,712, filed on Oct. 10, 2024.

(51) Int. Cl. H04L 1/00

(52) U.S. Cl. CPC H04L 1/0076

(57) ABSTRACT

A system and a method are disclosed for training an autoencoder. The method includes receiving, by an input of the autoencoder, a first bit sequence including a plurality of bit positions, determining, based on a first error probability associated with a first bit position of the plurality of bit positions, a first exponent value for the first bit position represented in a loss function, the first exponent value being proportional to the first error probability, and encoding, by the autoencoder or by a second autoencoder trained based on the first exponent value, a transmit signal.

### CROSS-REFERENCE TO RELATED APPLICATION

The present application claims the priority benefit under 35 U.S.C. § 119(c) of U.S. Provisional Application No. 63/705,712, filed on Oct. 10, 2024, the disclosure of which is incorporated by reference in its entirety as if fully set forth herein.

### TECHNICAL FIELD

The disclosure generally relates to communications. More particularly, the subject matter disclosed herein relates to improvements to systems and methods for channel coding using an autoencoder.

### SUMMARY

In the field of communications, error-correction coding is a technique used for reliable information processing in the presence of unavoidable random errors. In some communications systems (e.g., in some practical communication systems), channel coding is used as a building block to enable reliable communication by protecting the transmission of messages across a random noisy channel.

Channel coding is a fundamental area of interest in communication theory, and extensive theoretical research has led to the invention of several landmark codes. The design of such codes is an extremely difficult task, which relies on human intelligence, thus, slowing down new discoveries in the design of efficient encoders and decoders. With the success of artificial intelligence (AI) in many different domains, the coding theory community has become increasingly interested in methods for automating and accelerating the design of channel encoders and decoders by incorporating various tools from machine learning (ML).

In some systems, ML tools may be incorporated into the design of channel encoders and decoders by replacing the encoder and decoder (or some components within the encoder and decoder architectures) with neural networks or some other trainable ML models.

Training methods for neural channel codes have not been thoroughly explored. Aspects of embodiments of the present disclosure provide for improvements in channel encoders and decoders by providing improved methods for training channel autoencoders.

Aspects of embodiments of the present disclosure provide training methods for providing channel autoencoders with improved performance (e.g., with reduced error rates).

In some embodiments, the training methods include first pre-training the model on a first type of loss and then fine-tuning the model on a second loss that is different from the first type of loss.

In some embodiments, an improved loss function, referred to as an adaptively scaled norm (ASN) loss (e.g., ASN loss function), may be used for training. In some embodiments, the ASN loss function assigns unequal weights to each bit position, promoting accurate decoding of all bits and thereby improving overall error-rate performance.

Although the present disclosure refers to specific channel autoencoder architectures, it should be understood that the present disclosure is not limited thereto. For example, the ASN loss function and most of the arguments disclosed herein are applicable to any channel autoencoder.

In some embodiments, transformer layers may be incorporated into both the encoder and decoder, leading to further error-rate improvements.

According to some embodiments of the present disclosure, a method for training an autoencoder includes receiving, by an input of the autoencoder, a first bit sequence including a plurality of bit positions, determining, based on a first error probability associated with a first bit position of the plurality of bit positions, a first exponent value for the first bit position represented in a loss function, the first exponent value being proportional to the first error probability, and encoding, by the autoencoder or by a second autoencoder trained based on the first exponent value, a transmit signal.

The loss function may be a second loss function and the method may further include generating, by the autoencoder, a second bit sequence based on encoding and decoding the first bit sequence, the second bit sequence including a plurality of bit positions, determining, based on a first loss function that is different from the second loss function the first error probability, and a second error probability associated with a second bit position, the first error probability being different from the second error probability, determining, based on the second error probability, a second exponent value for the second bit position represented in the second loss function, the second exponent value being proportional to the second error probability, and being different from the first exponent value, and updating one or more parameters of a machine-learning (ML) model of the autoencoder based on the second loss function.

The first loss function may include a pre-training loss function for updating the one or more parameters of the ML model of the autoencoder during one or more initial iterations of the training.

The first loss function may include a binary cross-entropy (BCE) loss function.

The autoencoder may include an encoder configured to transmit encoded signals via a channel, the encoder including a first neural network, and a decoder configured to receive and decode the encoded signals from the channel, the decoder including a neural network.

The autoencoder may include an encoder configured to transmit encoded signals via a channel, the encoder including a transformer encoder.

The encoder may be a last encoding stage before the channel.

The autoencoder may include a decoder configured to receive and decode encoded signals from a channel, the decoder including a transformer encoder.

The decoder may be a first decoding stage after the channel.

The method may further include decoding, by the autoencoder, the transmit signal.

According to other embodiments of the present disclosure, a processing circuit for training an autoencoder includes the autoencoder, the autoencoder being trained to perform channel coding based on receiving, by an input of the autoencoder, a first bit sequence including a plurality of positions, determining, based on a first error probability associated with a first bit position of the plurality of positions, a first exponent value for the first bit position represented in a loss function, the first exponent value being proportional to the first error probability, and encoding, by the autoencoder or by a second autoencoder trained based on the first exponent value, a transmit signal.

The loss function may be a second loss function and the autoencoder may be trained to perform channel coding based on generating, by the autoencoder, a second bit sequence based on encoding and decoding the first bit sequence, the second bit sequence including a plurality of positions, determining, based on a first loss function that is different from the second loss function the first error probability, and a second error probability associated with a second bit position, the first error probability being different from the second error probability, determining, based on the second error probability, a second exponent value for the second bit position represented in the second loss function, the second exponent value being proportional to the second error probability, and being different from the first exponent value, and updating one or more parameters of a machine-learning (ML) model of the autoencoder based on the second loss function.

The first loss function may include a pre-training loss function for updating the one or more parameters of the ML model of the autoencoder during one or more initial iterations of training.

The first loss function may include a binary cross-entropy (BCE) loss function.

The autoencoder may include an encoder configured to transmit encoded signals via a channel, the encoder including a first neural network, and a decoder configured to receive and decode the encoded signals from the channel, the decoder including a neural network.

The autoencoder may include an encoder configured to transmit encoded signals via a channel, the encoder including a transformer encoder.

The encoder may be a last encoding stage before the channel.

The autoencoder may include a decoder configured to receive and decode encoded signals from a channel, the decoder including a transformer encoder.

According to other embodiments of the present disclosure, a system for training an autoencoder includes a user equipment (UE) including an autoencoder, wherein the UE is configured to transmit a first transmit signal encoded by the autoencoder, and the autoencoder is trained to perform channel coding based on receiving, by an input of the autoencoder, a first bit sequence including a plurality of positions, determining, based on a first error probability associated with a first bit position of the plurality of positions, a first exponent value for the first bit position represented in a loss function, the first exponent value being proportional to the first error probability, and encoding, by the autoencoder or by a second autoencoder trained based on the first exponent value, a transmit signal.

The UE may be configured to receive and decode, by the autoencoder, a second transmit signal.

### BRIEF DESCRIPTION OF THE DRAWING

In the following section, the aspects of the subject matter disclosed herein will be described with reference to exemplary embodiments illustrated in the figures.

FIG. 1A is a block diagram depicting a system including a UE and a network node for using one or more autoencoders trained using a method for autoencoder training, according to some embodiments of the present disclosure.

FIG. 1B is a block diagram depicting the basic structure of the autoencoder, according to some embodiments of the present disclosure.

FIG. 2A is a block diagram depicting details of an example autoencoder having multiple encoding stages (also referred to as encoder stages) and multiple decoding stages (also referred to as decoder stages), according to some embodiments of the present disclosure.

FIG. 2B is a diagram depicting symbols representing matrix processing orientations depicted in FIG. 2A, according to some embodiments of the present disclosure.

FIG. 2C is a block diagram depicting a transformer encoder used in the autoencoder, according to some embodiments of the present disclosure.

FIG. 3A and FIG. 3B (collectively, FIG. 3) are diagrams depicting operations of a method for training an autoencoder, according to some embodiments of the present disclosure.

FIG. 4 is a block diagram of an electronic device in a network environment, according to some embodiments of the present disclosure.

FIG. 5 is a flowchart depicting example operations of the method for training an autoencoder, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As discussed above, in the field of communications, error-correction coding is a technique used for reliable information processing in the presence of unavoidable random errors. In some communications systems (e.g., in some practical communication systems), channel coding is used as a building block to enable reliable communication by protecting the transmission of messages across a random noisy channel. For example, in some systems, a channel encoder maps a length-k sequence of information bits u to a length-n sequence of coded symbols c by adding some sort of redundancy. A decoder may exploit the redundancy to map noisy observations of codewords y back to information sequences u while minimizing the error rate. The parameters k and n are referred to respectively as the code dimension and blocklength. The resulting code is denoted by an (n, k) code.

Channel coding is a fundamental area of interest in communication theory, and decades of extensive theoretical research have led to the invention of several landmark codes, such as Turbo codes, low-density parity-check (LDPC) codes, and polar codes, among others. The design of such codes, however, is an extremely difficult task, which relies on human intelligence, thus, slowing down new discoveries in the design of efficient encoders and decoders. With the success of artificial intelligence (AI) in many different domains, the coding theory community has become increasingly interested in methods for automating and accelerating the design of channel encoders and decoders by incorporating various tools from machine learning (ML). Among the major advantages of ML-driven classes of codes, compared to classical codes, are their robustness to changes in the environment, as well as their ability to adapt to such changes.

In some systems, ML tools may be incorporated into the design of channel encoders and decoders by replacing the encoder and decoder (or some components within the encoder and decoder architectures) with neural networks or some other trainable ML models. Some ML-based channel codes can outperform traditional coding methods, particularly in scenarios with moderate block lengths.

Training methods for neural channel codes have not been thoroughly explored. Some systems focus on the design and structure of neural architectures but pay less attention to how these channel codes are trained. Some systems may be trained using a binary cross-entropy (BCE) loss, which, while effective in many contexts, such as bit error rate (BER) minimization, may not sufficiently minimize block error rate (BLER). Given that BLER measures the correctness of an entire block of bits, it may be suitable to apply loss functions that jointly penalize errors across all bit positions of a block to more effectively target BLER minimization. Systems incorporating BLER-specific training of channel autoencoders mostly focus on defining and applying several BLER-like loss functions for the training of a certain class of neural decoders for classical channel codes (e.g., for LDPC codes) under relatively short lengths. Aspects of embodiments of the present disclosure provide for improvements in channel encoders and decoders by providing methods for training channel autoencoders (e.g., for training both encoders and decoders) under BLER-specific loss functions.

Aspects of embodiments of the present disclosure provide training methods for channel autoencoders with improved (e.g., with optimized) BLER performance.

In some embodiments, the training methods include first pre-training the model on BCE loss and then fine-tuning the model on BLER-specific loss functions.

In some embodiments, an improved loss function, referred to as an adaptively scaled norm (ASN) loss (e.g., ASN loss function), may be used for training. The ASN loss function may dynamically adjust penalties (e.g., exponents of the ASN loss function) based on the bit positions with higher error rates, enabling the ASN loss function to be more effective for improved BLER performance (e.g., for BLER minimization). In some embodiments, the ASN loss function assigns unequal weights to each bit position, promoting the accurate decoding of all bits and thereby improving overall BLER performance. In some embodiments, a combination of BCE pretraining, followed by finetuning with the ASN loss function leads to significant BLER improvements compared to training solely with BCE.

Although the present disclosure refers to specific channel autoencoder architectures, it should be understood that the present disclosure is not limited thereto. For example, the ASN loss function and most of the arguments disclosed herein are applicable to any channel autoencoder.

In some embodiments, transformer layers may be incorporated into both the encoder and decoder, leading to further BLER improvements. For example, the transformer architecture may be incorporated into the encoding and decoding processes of neural channel codes. Transformers, initially designed for natural language processing tasks, can be effective in sequence modeling due to their attention mechanisms. The attention mechanism allows the ML model to capture dependencies and relationships between different parts of an input sequence, leading to more robust and accurate representations. By incorporating transformers into a neural channel-coding framework, the ability of the transformers to model complex dependencies may provide for improved performance of the coding system.

Training methodologies for neural channel codes provided by autoencoders have not been thoroughly explored. Some training approaches may provide for improvements in bit error rates but do not adequately improve block error rates. Some training approaches rely on loss functions that assign the same exponent value to the error probabilities of every bit position, which can cause a few bit positions having the highest error probabilities to dominate the loss function.

Aspects of some embodiments of the present disclosure use an improved loss function that is designed to improve block error rates. Aspects of some embodiments, assign exponent values to the error probabilities of the different bit positions that are proportional (e.g., directly proportional) to their corresponding error probabilities to more accurately model block error rates and improve performance.

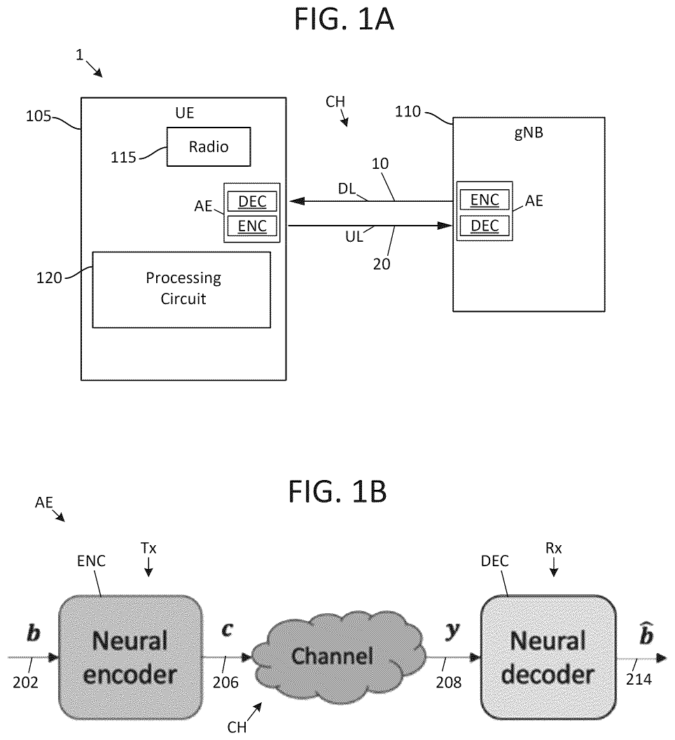

FIG. 1A is a block diagram depicting aspects of a system 1 (for performing communications with channel coding) including a user equipment (UE) 105 and a network node 110 (e.g., a base station, such as a gNodeB) for using one or more autoencoders AE trained using a method for autoencoder training, according to some embodiments of the present disclosure.

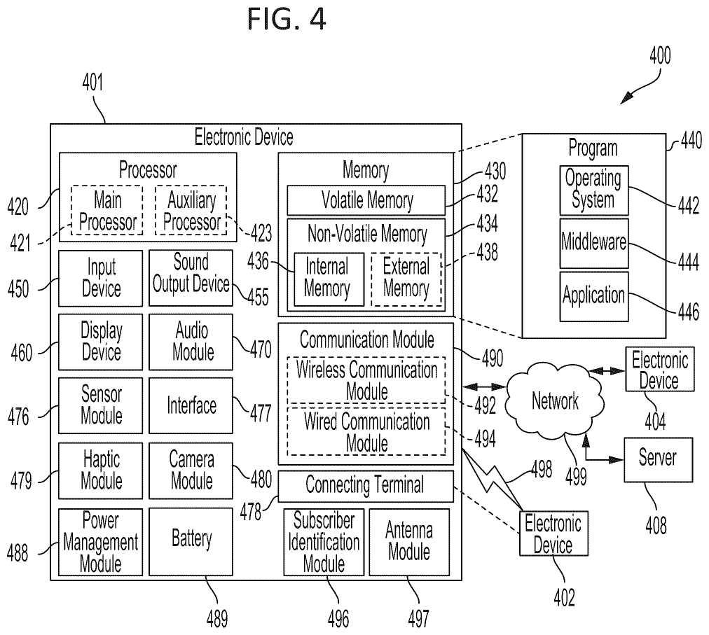

Referring to FIG. 1A, the system 1 may include one or more network nodes 110 and/or one or more UEs 105. In some embodiments, each of the devices (e.g., each of the UEs 105) may be capable of receiving DL transmissions 10 from the other devices (e.g., from the network nodes 110) and may be capable of sending UL transmissions 20 to the other devices (e.g., to the network nodes 110). A given UE 105 may include a radio 115 and a means for processing. The means for processing may include a processing circuit 120, which may perform various methods disclosed herein. The radio 115 may correspond to the communication module 490 (see FIG. 4). The processing circuit 120 may correspond to the processor 420 (see FIG. 4). As used herein, the term “UE” is used broadly to refer to electronic communications devices. For example, UEs may include computers, mobile phones, tablets, vehicles, satellites, IoT devices, and/or the like.

One or more of the devices (e.g., one or more UEs 105 and one or more network nodes 110) in the system 1 may include an autoencoder AE. As used herein, the term “autoencoder” refers to a device (e.g., a hardware and/or software device) comprising an ML-based encoder ENC (e.g., a neural encoder) and an ML-based decoder DEC (e.g., a neural decoder) comprising ML models trained to learn parameters for performing encoding and decoding of communications signals. For example, the UE 105 may receive a signal (e.g., a given DL transmission 10) sent via a channel CH from the network node 110. The UE 105 may use the decoder DEC of its autoencoder AE to decode the received signal. The UE 105 may transmit a signal (e.g., a given UL transmission 20) to the network node 110. The UE 105 may use the encoder ENC of its autoencoder AE to encode the transmit signal for transmission via the channel CH. The network node 110 may use a decoder DEC of its autoencoder AE to decode the signal received from the UE 105. Likewise, the UE 105 may use its autoencoder AE to encode and decode signals sent to and/or received from other UEs 105. In other words, the UE 105 may be configured to transmit encoded signals via the channel CH and/or to receive and decode encoded signals from the channel CH based on the autoencoder AE.

FIG. 1B is a block diagram depicting the basic structure of the autoencoder AE, according to some embodiments of the present disclosure.

Referring to FIG. 1B, a transmitter side Tx of the autoencoder AE may include the encoder ENC. A receiver side Rx of the autoencoder AE may include the decoder DEC. As discussed above, the encoder ENC may encode signals before the signals are transmitted via the channel CH to another device (e.g., to another UE 105 or to the network node 110). The decoder DEC may decode signals after the signals are received from the channel CH (e.g., from another UE 105 or from the network node 110). The channel CH may be noisy and, thus, may degrade the signals transmitted therethrough. The signals transmitted via the channel CH may be encoded by encoders ENC to have redundant bits to help recover the original data (e.g., the original information) sent in the signal. For example, the redundant bits may help a given UE 105 determine when errors have occurred in the data transmission and may help the given UE 105 recover the original data without errors.

In some embodiments, an autoencoder may be trained by comparing a signal (e.g., a first bit sequence, b) provided to an encoder input 202 with a signal (e.g., a second bit sequence, \hat{b}, also referred to as “b hat”) corresponding with a decoder output 214. For example, a loss function may be determined based on comparing inputs and outputs of the autoencoder AE and the loss function may be used to adjust the parameters of the autoencoder to achieve an output signal (e.g., an output bit sequence) that is the same as, or suitably close to, the input signal (e.g., the first bit sequence). For example, adjusting the parameters based on the loss function may reduce error rates (e.g., may reduce BLER).

In some embodiments, the encoder ENC of the autoencoder AE may encode an input binary sequence b to generate a coded transmit signal c (e.g., a length-n sequence of coded symbols), which may be transmitted across the channel CH (e.g., a real-world channel or a simulated channel). The decoder DEC of the autoencoder AE may decode a coded received signal y (e.g., noisy codewords) to generate an output binary sequence b\hat{ } (b hat). A loss function may be determined based on comparing the input binary sequence b with the output binary sequence b\hat{ } (b hat). Additional iterations of encoding and decoding may be performed with the autoencoder AE to update the loss function (e.g., by updating parameters of the autoencoder AE based on updating the loss function) to determine a suitable loss function for encoding and decoding signals (e.g., for encoding and decoding bit sequences) transmitted and/or received via the channel CH.

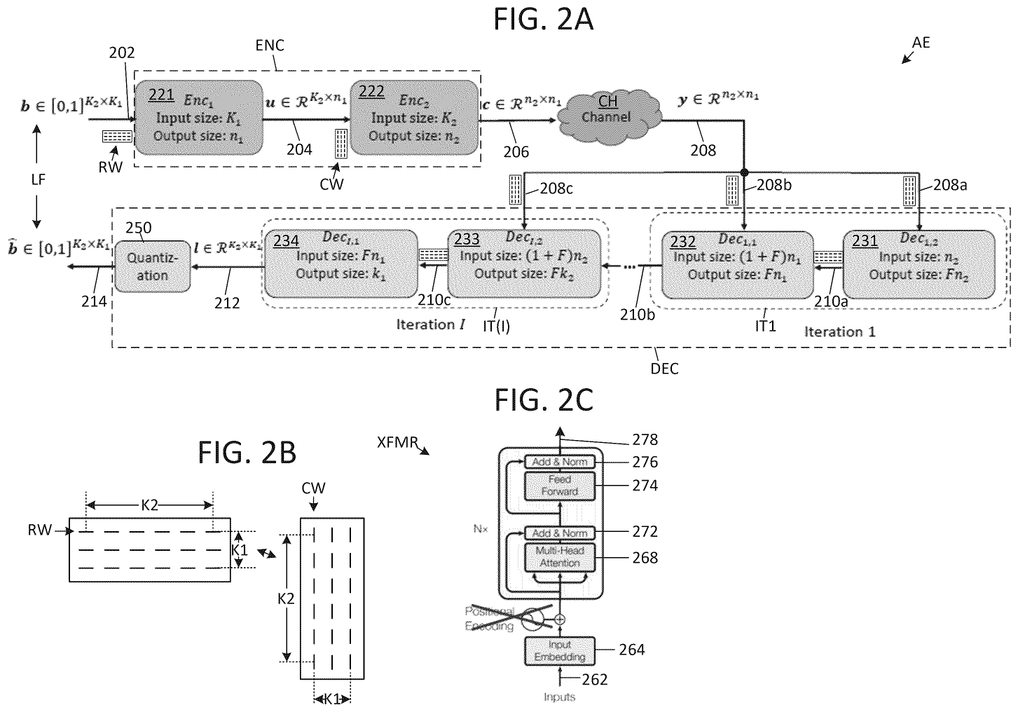

FIG. 2A is a block diagram depicting details of an example autoencoder AE having multiple encoding stages and multiple decoding stages, according to some embodiments of the present disclosure.

FIG. 2B is a diagram depicting symbols representing matrix processing orientations depicted in FIG. 2A, according to some embodiments of the present disclosure.

Referring to FIG. 2A, the autoencoder AE may include an encoder ENC and a decoder DEC. The encoder ENC may include one or more encoding stages (e.g., one or more encoding circuits). For example, in some embodiments, the encoder ENC includes a first encoding stage 221 and a second encoding stage 222. In some embodiments, the second encoding stage 222 is the last encoding stage before the channel CH. The decoder DEC may include one or more decoding stages (e.g., one or more decoding circuits). For example, in some embodiments, the decoder DEC includes a first decoding stage 231, a second decoding stage 232, a third decoding stage 233, and a fourth decoding stage 234. In some embodiments, the decoder DEC may include multiple iterations of decoding-stage pairs. For example, the first decoding stage 231 and the second decoding stage 232 may be a first iteration of decoding-stage pairs following the channel CH. In some embodiments, the third decoding stage 233 and the fourth decoding stage 234 may be an I-th iteration of decoding-stage pairs following the channel CH. In some embodiments, each first decoding stage (e.g., 231 and 233) of the decoding-stage pairs (e.g., the pair including 231 and 232 and the pair including 233 and 234) may receive the same bit signal from the channel CH (e.g., the channel output y). For example, the signal from the channel CH may be provided to a first decoding-stage input 208a, to a second decoding-stage input 208b, and to a third decoding-stage input 208c. In some embodiments, the third decoding-stage input 208c may be referred to as an I-th decoding-stage input. For example, the third decoding stage 233 may be preceded by additional iterations of decoding stages (which are not depicted in FIG. 2A).

In some embodiments, the first decoding stage 231 may be referred to as the first decoding stage following the channel CH because it does not receive an output from the other decoding stages and, thus, there is not another decoding stage between the channel CH and the first decoding stage 231. In some embodiments, a first decoding-stage output 210a may be provided to the second decoding stage 232, a second decoding-stage output 210b may be provided to the third decoding stage 233 (or to an earlier decoding stage between the second decoding stage 232 and the third decoding stage 233 if there is one). In some embodiments, a third decoding-stage output 210c may be provided to the fourth decoding stage 234. In some embodiments, the fourth decoding stage 234 does not receive input directly from the channel CH. In some embodiments, following the structure of the soft-input soft-output (SISO) decoder for classical product codes, in addition to the output from the previous decoder (e.g., the previous decoding stage), the channel output from the channel CH may also be passed to each decoding stage, except for the last decoding stage (e.g., the fourth decoding stage 234). The last decoding stage may not receive the channel output from the channel CH due to issues with the size of tensors being concatenated at the input of the last decoding stage.

In some embodiments, a last decoding-stage output 212 may be provided to a quantization stage 250 (e.g., a quantization circuit). In some embodiments, an output of the quantization stage 250 may correspond to a decoder output 214.

Referring to FIG. 2A and FIG. 2B, the signals (e.g., bit sequences) processed by the autoencoder AE may be processed, by the encoding stages and the decoding stages of the autoencoder AE, according to different orientations (e.g., row-wise RW or column-wise CW). For example, the input binary sequence b, which is provided to the encoder input 202 may include (e.g., may be) a matrix of K2×K1 information bits. For example, the matrix may include K1 rows and K2 columns. The first encoding stage 221 may encode the rows of the matrix in a row-wise manner and the second encoding stage 222 may encode the columns of the matrix in a column-wise manner. For example, the first encoding stage 221 may add redundancies to the input binary sequence b in a row-wise manner, and the second encoding stage 222 may add redundancies to the first encoding-stage output 204 in a column-wise manner. In some embodiments, an encoder output 206 may include n2×n1 coded symbols to be transmitted across the channel CH. The output signal from the encoder output 206 may be referred to as a coded transmit signal c. The coded transmit signal c may include (e.g., may be) a length-n sequence of coded symbols.

In some embodiments, the last decoding-stage output 212 may include logits l, which may be used to determine the loss function LF. The loss function LF may be referred to as a function that compares the input binary sequence b (e.g., the original signal provided to the encoder input 202) with the output binary sequence \hat{b} (e.g., the estimated signal at the receiver). The loss function LF may provide a measure of the mismatch (e.g., the error) between the input binary sequence b and the output binary sequence \hat{b}. For example, the loss function may mimic the error rate of the autoencoder AE and may be used to minimize the error rate. For example, the gradient of the loss function LF may be determined and used to modify the parameters of the neural networks (NNs) of the autoencoder AE, such that the error between the input binary sequence b and the output binary sequence \hat{b} decreases.

In the example autoencoder AE of FIG. 2A, the encoding process involves two stages: outer and inner encoding. The first encoder (Enc₁) (also referred to as the first encoding stage 221) processes the binary sequence b∈[0,1]^{K}^{₂}^{×K}^{₁}, outputting u∈ [symbol] ^{K}^{₂}^{×n}^{₁} through row-wise encoding. The second encoder (Enc₂) (also referred to as the second encoding stage 222) then takes u as input and produces c∈ [symbol] ⁿ^{₂}^{×n}^{₁} through column-wise encoding, which is then transmitted over the channel CH.

In the example autoencoder AE of FIG. 2A, the decoding also involves two stages repeated over I iterations, where I is a whole number. In some embodiments, to improve the decoding performance, the output of the last decoding stage (e.g., the fourth decoding stage 234) may be fed back as the input to the decoder DEC (e.g., to the input of the first decoding stage 231). Each iteration may include two decoders (e.g., two decoding stages) handling the outer and inner codes. In some embodiments, during every iteration, the first decoder (e.g., the first decoding stage 231 and/or the third decoding stage 233) decodes the columns while the second decoder (e.g., the second decoding stage 232 and/or the fourth decoding stage 234) decodes the rows. After I iterations, the network may output \hat{b}∈[0,1]^{K}^{₂}^{×K}^{₁}. In some embodiments, the encoders (e.g., the decoding stages) and decoders (e.g., the decoding stage) may include (e.g., may be fully connected networks with non-linear activations). In some embodiments, the entire network is trained to minimize the binary cross entropy (BCE) between the input bits and the predicted bits (e.g., between b and \hat{b}).

It should be understood from FIG. 2A that, for a given I (a given number of iterations), there are 2*I decoding blocks. For example, if I=2, there are 4 blocks as depicted in FIG. 2A. If I is larger than 2, there is a larger number of decoding blocks arranged sequentially. That is, there would be additional decoding stages between the second decoding-stage output and the input of the third decoding stage 233.

Although the present disclosure discusses structures and functions of the example autoencoder AE of FIG. 2A, it should be understood that the present disclosure is not limited thereto. For example, any suitable autoencoder may achieve performance gains (e.g., error reduction) based on aspects of embodiments of the present disclosure.

FIG. 2C is a block diagram depicting a transformer encoder used in the autoencoder, according to some embodiments of the present disclosure.

In some embodiments, one or more of the encoding stages and/or the decoding stages may include ML models (e.g., NNs, such as fully connected NNs). Referring to FIG. 2C, in some embodiments, one or more of the encoding stages and/or the decoding stages may include a transformer encoder XFMR instead of an NN). In some embodiments, the transformer encoder XFMR may not use positional encoding. Positional encoding may be used in other transformer applications. In some embodiments, the transformer encoder XFMR may be used in the last encoding stage before the channel CH (e.g., in the second encoding stage 222) and/or in the first decoding stage after the channel CH (e.g., in the first decoding stage 231). In some embodiments, the transformer encoder XFMR may include: a transformer input 262, an input embedding 264, a multi-head attention operation 268, a first add-and-norm operation 272, a feed-forward operation 274, a second add-and-norm operation 276, and a transformer output 278. In some embodiments, the transformer input 262 may correspond to the input of the respective encoding or decoding stage, and the transformer output 278 may correspond to the output of the respective encoding or decoding stage.

The encoder part of a transformer can be utilized in tasks that demand a deep understanding of input sequences without the need to generate new output sequences. Aspects of some embodiments of the present disclosure may leverage the encoder section of the transformer. For example, the input embedding 264 may map each element of an input sequence to a learnable embedding vector in [symbol] ^{d}. In such embodiments, the core of the transformer encoder XFMR is the multi-head attention mechanism (e.g., the multi-head attention operation 268), which captures relationships between different input embedding vectors by splitting the computation into h heads. In some embodiments, this approach enhances performance by enabling ML models to capture various aspects of the input data. The multi-head attention operation 268 may be followed by a feedforward neural network applied to each position separately and identically (e.g., by applying the feed-forward operation 274) to further refine the representation. Both the multi-head attention and feedforward network may each be followed by an “Add and Norm” step (e.g., the first add-and-norm operation 272 and the second add-and-norm operation 276), wherein the input to each sub-layer is added to its output (e.g., via residual connections) and then normalized to enable stable and efficient training.

In some embodiments, this sequence of operations, including multi-head attention, feedforward network, and “Add and Norm,” may be repeated N times, forming the layers of the transformer encoder XFMR. In some embodiments, the following hyperparameters may be used: embedding dimensions (d)=8, a number of attention heads (h)=4, and a number of layers (N)=3.

In some embodiments, one or more encoders and decoders (e.g., all encoders and decoders) may be provided with transformer encoders XFMR, instead of fully connected NNs. In some embodiments, improved results can be achieved by using a transformer encoder XFMR as the second encoder (e.g., the second encoding stage 222) and another transformer encoder XFMR as the first decoder (e.g., the first decoding stage 231). In such embodiments, the second encoder, positioned right before the channel CH, captures the complexity of the input sequence, enhancing the encoding process. Additionally, the first decoder, placed immediately after the channel CH, effectively decodes the channel's output. This configuration can be beneficial because the second encoder can optimally prepare the data for transmission through the channel CH, while the first decoder can efficiently reconstruct the input sequence from the channel's output, leveraging the strengths of the transformer architecture in understanding complex dependencies within the data.

Aspects of some embodiments of the present disclosure provide for training methods to determine an improved loss function LF (also referred to herein as the “ASN loss function”) that mimics the block error rate (BLER) of the autoencoder AE more accurately than other loss functions. The improved loss function LF may be used to update parameters of the autoencoder AE for a reduction in error (e.g., for a reduction in BLER) compared to other approaches. That is, by performing encoding of a bit sequence and/or by performing decoding of a bit sequence using a given autoencoder AE that is trained based on the improved loss function LF, the autoencoder may reduce error rates between a given input binary sequence b and a corresponding output binary sequence \hat{b}.

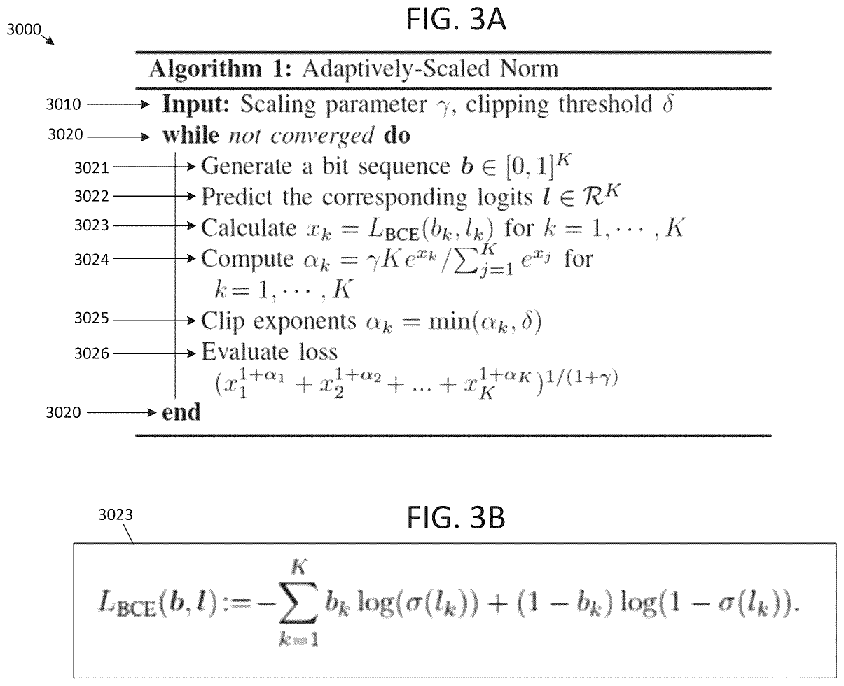

FIG. 3A and FIG. 3B (collectively, FIG. 3) are diagrams depicting operations of a method 3000 for training the autoencoder AE, according to some embodiments of the present disclosure.

Referring to FIG. 3A, the training of the autoencoder AE (such as the autoencoders discussed with reference to FIGS. 1A, 1B, and 2A), based on the improved loss function LF of equation 1 (eqn. 1) below, may enable the autoencoder AE to encode and/or decode signals with improved performance (e.g., reduced errors, such as BLER). The loss function of equation 1 may be referred to as an adaptively scaled norm (ASN) loss function and is represented mathematically as follows:

$${l}_{ASN} = {( {x}_{1}^{1 + {α}_{1}} + {x}_{2}^{1 + {α}_{2}} + … + {x}_{K}^{1 + {α}_{K}} )}^{\frac{1}{1 + γ}} \qquad ( eqn . 1 )$$

wherein: xₖ refers to the BCE (e.g., an error probability) for a given bit position of a total number of K bit positions of a given binary sequence, γ refers to a constant (e.g., a hyperparameter), and

$${α}_{k} = \frac{K γ {e}^{{x}_{k}}}{{\sum }_{j = 1}^{K} {e}^{{x}_{j}}} .$$

In some approaches to training autoencoders AE, the loss function LF may be a p-norm loss function

$${l}_{p} ( b , l ) = {( {x}_{1}^{p} + … + {x}_{K}^{p} )}^{\frac{1}{p}} ,$$

wherein p≥1. As can be seen by comparing exponents of the ASN loss function of eqn. 1 with the exponents of the p-norm loss function, the p-norm loss function applies the same exponent p for all values of xₖ (e.g., for all the error probabilities of the different bit positions). Contrastingly, the ASN loss function raises each value of xₖ (e.g., each error probability of the different bit positions) to a power proportional to its value (e.g., directly proportional to the error probability of its corresponding bit position).

For example, a first bit position (e.g., any one of bit positions 1 to K) may have an error probability of, for example, x₅ (for bit position number 5), which is a different error probability than that of a second bit position, for example, x₈ (for bit position number 8). Accordingly, the exponent value for the first bit position would be different than the exponent value for the second bit position (e.g., (1+α₅) for bit position number 5 and (1+α₈) for bit position number 8). By raising each value of to a power proportional to its value, the ASN loss function allows NN parameters to be selected by paying more attention to bit positions with higher chances of error while balancing the attention with other bit positions, such that the other bit positions having lower chances of error are not ignored (e.g., are not ignored as much as they would be using, for example, the p-norm loss function). Additionally, the error probabilities xx are values between 0 and 1, wherein a value that is closer to 0 has a lower chance of error than a value that is closer to 1 (i.e., the value closer to 1 has a higher chance of error than the value closer to 0). As such, raising each value of xₖ to an exponent that is based on xₖ, instead of the same value of p≥1 (as in the p-norm loss function), helps avoid scenarios where one bit position having a high probability of error dominates the attention of the loss function.

In some embodiments, the outer exponent associated with the ASN loss function is calculated as

$$\frac{1}{K} {\sum }_{k = 1}^{K} ( 1 + α {k}_{} ) = 1 + γ$$

(as opposed to

$$\frac{1}{K} {\sum }_{k = 1}^{K} p$$

for the p-norm loss).

In some embodiments, to avoid an issue in which the loss (e.g., the ASN loss function) results in exploding exponents due to the power operation (x\hat{ }(1+α)) reaching infinity (∞) and leading to training problems, the exponents of the ASN loss function may be clipped (e.g., may be calculated with an upper bound). In such embodiments, an algorithm for calculating the ASN loss function for training the autoencoder AE may be determined based on the following operations:
Operation A1: Set the scaling parameter γ (e.g., γ=3).
Operation A2: Set the clipping threshold δ (e.g., δ=5).
Operation A3: Calculate x=BCE(b, σ(l)).
Operation A4: Calculate α where

$${α}_{k} = \frac{K γ {e}^{{x}_{k}}}{{\sum }_{j = 1}^{K} {e}^{{x}_{j}}}$$

for k=1, . . . , K.
Operation A5: Clip exponents: αₖ=min(αₖ, δ).
Operation A6: Calculate loss:

$${( {x}_{1}^{1 + {α}_{1}} + {x}_{2}^{1 + {α}_{2}} + … + {x}_{K}^{1 + {α}_{K}} )}^{\frac{1}{1 + γ}} .$$

In some embodiments, to avoid the issue in which the loss (e.g., the ASN loss function) results in exploding exponents due to the power operation (x\hat{ }(1+α)) reaching infinity (∞) and leading to training problems, the exponents of the ASN loss function may be chosen while avoiding big numbers (e.g., while avoiding numbers greater than a threshold).

In some embodiments, to avoid the issue in which the loss (e.g., the ASN loss function) results in exploding exponents due to the power operation (x\hat{ }(1+α)) reaching infinity (∞) and leading to training problems, the inputs may be transformed using a logarithmic scale before applying a softmax function, making the values less extreme, such that algorithm for calculating the ASN loss function for training the autoencoder AE may be determined based on the following operations:
Operation B1:

$$Calculate x = log ( 1 + BCE ( b , σ ( l ) ) ) .$$

Operation B2:

$$Calculate α where {α}_{k} = \frac{K γ {e}^{{x}_{k}}}{{\sum }_{j = 1}^{K} {e}^{{x}_{j}}}$$

for k=1, . . . , K.
Operation B3: Calculate loss:

$${( {x}_{1}^{1 + {α}_{1}} + {x}_{2}^{1 + {α}_{2}} + … + {x}_{K}^{1 + {α}_{K}} )}^{\frac{1}{1 + γ}} .$$

Referring still to FIG. 3A, in some embodiments, the method 3000 for training the autoencoder AE may include one or more of the following operations (some of which correspond to operations A1 to A6 discussed above).

The autoencoder AE, or a processing circuit 120 associated with the autoencoder, may set the training hyperparameters γ and δ, wherein γ refers to the scaling parameter and δ refers to the clipping threshold (operation 3010).

The autoencoder AE, or a processing circuit 120 associated with the autoencoder AE, may generate the input bit sequence b and pass the bit sequence b through the channel CH (operation 3021).

The autoencoder AE, or a processing circuit 120 associated with the autoencoder AE, may perform the decoding to generate (e.g., to predict) the corresponding logits l (operation 3022). The logits may be considered as estimations of the input bit sequence and are similar to the output binary sequence \hat{b}.

The autoencoder AE, or a processing circuit 120 associated with the autoencoder AE, may calculate the BCEs (e.g., the error probabilities) xₖ associated with each bit position of the bit sequence (operation 3023). Referring to FIGS. 3A and 3B, in some embodiments, the BCEs may be determined using the BCE loss function equation of FIG. 3B.

The autoencoder AE, or a processing circuit 120 associated with the autoencoder AE, may calculate (e.g., may compute) the ASN loss-function exponent value αₖ (operation 3024).

The autoencoder AE, or a processing circuit 120 associated with the autoencoder AE, may determine an upper bound threshold (e.g., a tuning hyperparameter) for the ASN loss-function exponent value αₖ, as discussed above, to prevent training issues and provide numerical stability (operation 3025).

The autoencoder AE, or a processing circuit 120 associated with the autoencoder AE, may evaluate the loss using the ASN loss function (operation 3026).

As part of the training process for the autoencoder AE, the autoencoder AE, or a processing circuit 120 associated with the autoencoder AE, may take the gradient of the ASN loss function to adjust the parameters of the NNs of the autoencoder AE until a suitable performance is achieved (e.g., until the algorithm converges to a suitable performance metric, such as a suitable BLER) (operation 3020). In other words, the operations 3021 through 3026 (e.g., one or more of the operations 3021, 3022, 3023, 3024, 3025, and/or 3026) may be performed over a number of iterations until a suitable autoencoder performance is achieved.

In some embodiments, the autoencoder AE may be pre-trained on BCE (e.g., using the BCE loss function of FIG. 3B) and then fine-tuned using the ASN loss function. For example, the BCE loss function may be used to update parameters of the NNs for a first given number of initial iterations of training or until a convergence to a first suitable performance metric (e.g., BLER) is achieved. After the first given number of initial iterations or the first suitable performance metric is achieved, the ASN loss function may be used to update parameters of the NNs for a second given number of iterations of training or until a convergence to a second suitable performance metric (BLER) is achieved. For example, in some embodiments, a pre-training phase may include the operations of 3021, 3022, and 3023 (without operations of 3024, 3025, and 3026) of FIG. 3A discussed above. In other words, the loss evaluation of operation 3026 may be based on the BCE loss function serving as a pre-training loss function, instead of the ASN loss function. In such embodiments, the operations of 3021 through 3026 (with the operations 3024, 3025, and 3026 including loss evaluation with the ASN loss function) may be performed after the pre-training phase.

In some embodiments, the pre-training and/or training may include curriculum learning. Curriculum learning is a training strategy in machine learning where an ML model is exposed to training data in a gradually increasing order of difficulty. Inspired by the way humans learn, such embodiments may begin with simpler examples and progressively introduce more complex ones as the ML model's performance improves. The idea is that by starting with casier tasks, the ML model can build a strong foundation and learn more effectively when faced with challenging data. In some embodiments, curriculum learning can enhance convergence speed, improve generalization, and lead to better overall performance. In some embodiments, curriculum learning may include training one or more ML models of the autoencoder AE on a first loss function (e.g., 1-norm) for 200 epochs, then training on a second loss function (e.g., 2-norm) for another 200 epochs, then training on a third loss function (e.g., 3-norm) for another 200 epochs, and so on.

In some embodiments, the autoencoder AE may be pre-trained using either BCE, 2-norm, or a curriculum approach, followed by finetuning on the ASN loss function (eqn. 1 above).

FIG. 4 is a block diagram of an electronic device in a network environment 400, according to some embodiments of the present disclosure.

Referring to FIG. 4, an electronic device 401 (e.g., a UE) in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

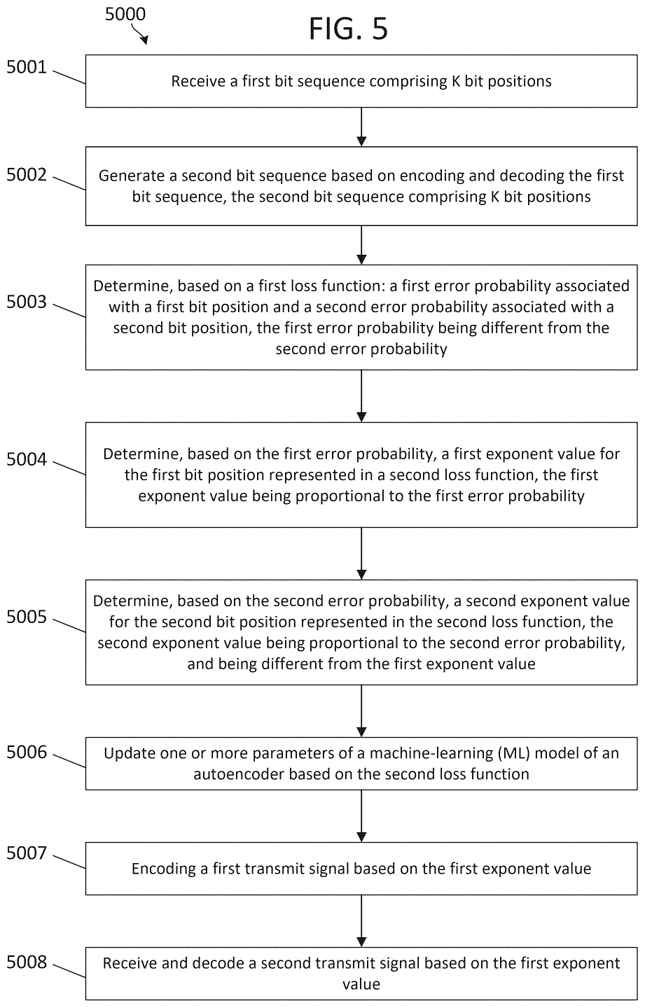

As discussed above, the processing circuit 120 (see FIG. 1A), may perform the various methods disclosed herein and may correspond to the processor 420 discussed above with reference to FIG. 4. For example, the processor 420 may perform the method 3000 and/or a method 5000, which is discussed in further detail below with reference to FIG. 5. The radio 115 (see FIG. 1A) may correspond to the communication module 490 (see FIG. 4). In some embodiments, the autoencoder AE may be a component of the communication module 490 and/or may be a component of the processor 420. For example, the processor 420 and the communication module 490 may perform channel-coding operations using the autoencoder AE.

In some embodiments, the electronic device 401 may encode a transmit signal using the encoder ENC of the autoencoder AE and may send the encoded version of the transmit signal to the electronic device 402 or to the network 499. In some embodiments, the electronic device 401 may receive and decode a transmit signal, from the electronic device 402 or from the network 499, using the decoder DEC of the autoencoder AE.

FIG. 5 is a flowchart depicting example operations of the method 5000 for training an autoencoder, according to some embodiments of the present disclosure. Although FIG. 5 illustrates various operations in a method for training an autoencoder, embodiments according to the present disclosure are not limited thereto, and according to various embodiments, the method may include additional operations, or fewer operations, or the order of operations may vary, unless otherwise stated or implied, without departing from the spirit and scope of embodiments according to the present disclosure.

Referring to FIG. 5, the method 5000 may include one or more of the following operations. An autoencoder AE may receive a first bit sequence (e.g., b) comprising a plurality of bit positions (e.g., K bit positions, K being an integer greater than one) (operation 5001).

For example, as discussed above, the input binary sequence b, which is provided to the encoder input 202 may include (e.g., may be) a matrix of K2×K1 information bits.

The autoencoder AE may generate a second bit sequence (e.g., \hat{b}) based on encoding and decoding the first bit sequence (e.g., based on encoding and decoding signals associated with the first bit sequence) (operation 5002).

For example, as discussed above and as depicted in FIG. 1B, the second bit sequence (e.g., \hat{b}) may be generated at the decoder output 214 after encoding by the encoder ENC and decoding by the decoder DEC.

The autoencoder AE, or a processing circuit 120 associated with the autoencoder AE, may determine, based on a first loss function (e.g., pre-training function or an earlier iteration of an ASN loss function): a first error probability (e.g., x_k) associated with a first bit position (e.g., any one of the K bit positions) and a second error probability (e.g., x_k) associated with a second bit position (e.g., any other one of the K bit positions) (operation 5003). The first error probability may be different from (e.g., greater or less than) the second error probability.

For example, as discussed above, the ASN loss function raises each value of xₖ (e.g., each error probability of the different bit positions) to a power proportional to its value (e.g., directly proportional to the error probability of its corresponding bit position).

The autoencoder AE, or the processing circuit 120 associated with the autoencoder AE, may determine, based on the first error probability, a first exponent value (e.g., 1+αₖ) for the first bit position represented in a second loss function/the ASN loss function (e.g.,

$${l}_{ASN} = {( {x}_{1}^{1 + {α}_{1}} + {x}_{2}^{1 + {α}_{2}} + … + {x}_{K}^{1 + {α}_{K}} )}^{\frac{1}{1 + γ}}$$

(operation 5004). The first exponent value may be proportional to the first error probability

$$( e . g . , {α}_{k} = \frac{K γ {e}^{{x}_{k}}}{{\sum }_{j = 1}^{K} {e}^{{x}_{j}}} ) .$$

For example, as discussed above, the first exponent value may be a value from 0 to 1 and may be greater for bit positions that have a higher chance of error (e.g., that have a greater error probability). Accordingly, the autoencoder may be configured to pay more attention to bit positions with higher chances of error while still paying attention to all bit positions.

The autoencoder AE, or the processing circuit 120 associated with the autoencoder AE, may determine, based on the second error probability, a second exponent value (e.g., 1+αₖ) for the second bit position represented in the second loss funcuon

$$( e . g . , {l}_{ASN} = {( {x}_{1}^{1 + {α}_{1}} + {x}_{2}^{1 + {α}_{2}} + … + {x}_{K}^{1 + {α}_{K}} )}^{\frac{1}{1 + γ}}$$

(operation 5005). The second exponent value may be proportional to the second error probability

$$( e . g . , {α}_{k} = \frac{K γ {e}^{{x}_{k}}}{{\sum }_{j = 1}^{K} {e}^{{x}_{j}}} ) .$$

For example, as discussed above, and like the first exponent value, the second exponent value may be a value from 0 to 1 and may be greater for bit positions that have a higher chance of error (e.g., that have a greater error probability). Based on the first error probability being different from the second error probability, the second exponent value may be determined such that it is different from the first exponent value. For example, if the second error probability is greater than the first error probability, then the second exponent value may be determined such that it is greater than the first exponent value. On the other hand, if the second error probability is less than the first error probability, then the second exponent value may be determined such that it is less than the first exponent value. The first exponent value and the second exponent value may be determined such that they are proportional to the associated error probabilities of their respective bit positions.

The autoencoder AE, or the processing circuit 120 associated with the autoencoder AE, may update one or more parameters of an ML model of the autoencoder AE and/or a different autoencoder AE based on the second loss function (operation 5006).

For example, as discussed above one or more ML models associated with an encoder and/or associated with a decoder of the autoencoder AE may be trained by updating its parameters based on the gradient of the ASN loss function. Additionally, or alternatively, a different/second autoencoder AE may have its parameters updated based on the ASN loss function (e.g., during a manufacturing or updating process).

The autoencoder AE, the second autoencoder AE, and/or the processing circuit 120 associated with the autoencoder AE, may encode a signal (e.g., a first transmit signal) based on the first exponent value and/or the second exponent value (e.g., based on the updating of the parameters of the ML model of the autoencoder AE and/or the second autoencoder AE) (operation 5007).

For example, as discussed above with reference to FIGS. 1A and 1B, a UE 105 that includes the autoencoder AE may be configured to encode a signal for transmission (e.g., the transmit signal) to another UE 105 or to a network node 110 and may transmit the encoded transmit signal). Alternatively, the UE 105 that includes the autoencoder AE may be configured to decode a received signal from another UE 105 or from the network node 110.

The autoencoder AE, the second autoencoder AE, and/or the processing circuit 120 associated with the autoencoder AE, may receive and decode another signal (e.g., a second transmit signal) based on the first exponent value and/or the second exponent value (e.g., based on the updating of the parameters of the ML model of the autoencoder AE and/or the second autoencoder AE) (operation 5008).

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for training an autoencoder, the method comprising:
receiving, by an input of the autoencoder, a first bit sequence comprising a plurality of bit positions;
determining, based on a first error probability associated with a first bit position of the plurality of bit positions, a first exponent value for the first bit position represented in a loss function, the first exponent value being proportional to the first error probability; and
encoding, by the autoencoder or by a second autoencoder trained based on the first exponent value, a transmit signal.

2. The method of claim 1, wherein the loss function is a second loss function and the method further comprises:
generating, by the autoencoder, a second bit sequence based on encoding and decoding the first bit sequence, the second bit sequence comprising a plurality of bit positions;
determining, based on a first loss function that is different from the second loss function:
the first error probability; and
a second error probability associated with a second bit position, the first error probability being different from the second error probability;
determining, based on the second error probability, a second exponent value for the second bit position represented in the second loss function, the second exponent value being proportional to the second error probability, and being different from the first exponent value; and
updating one or more parameters of a machine-learning (ML) model of the autoencoder based on the second loss function.

3. The method of claim 2, wherein the first loss function comprises a pre-training loss function for updating the one or more parameters of the ML model of the autoencoder during one or more initial iterations of the training.

4. The method of claim 2, wherein the first loss function comprises a binary cross-entropy (BCE) loss function.

5. The method of claim 1, wherein the autoencoder comprises:
an encoder configured to transmit encoded signals via a channel, the encoder comprising a first neural network; and
a decoder configured to receive and decode the encoded signals from the channel, the decoder comprising a neural network.

6. The method of claim 1, wherein the autoencoder comprises an encoder configured to transmit encoded signals via a channel, the encoder comprising a transformer encoder.

7. The method of claim 6, wherein the encoder is a last encoding stage before the channel.

8. The method of claim 1, wherein the autoencoder comprises a decoder configured to receive and decode encoded signals from a channel, the decoder comprising a transformer encoder.

9. The method of claim 8, wherein the decoder is a first decoding stage after the channel.

10. The method of claim 1, further comprising decoding, by the autoencoder, the transmit signal.

11. A processing circuit comprising:
an autoencoder, the autoencoder being trained to perform channel coding based on:
receiving, by an input of the autoencoder, a first bit sequence comprising a plurality of positions;
determining, based on a first error probability associated with a first bit position of the plurality of positions, a first exponent value for the first bit position represented in a loss function, the first exponent value being proportional to the first error probability; and
encoding, by the autoencoder or by a second autoencoder trained based on the first exponent value, a transmit signal.

12. The processing circuit of claim 11, wherein the loss function is a second loss function and the autoencoder is trained to perform channel coding based on:
generating, by the autoencoder, a second bit sequence based on encoding and decoding the first bit sequence, the second bit sequence comprising a plurality of positions;
determining, based on a first loss function that is different from the second loss function:
the first error probability; and
a second error probability associated with a second bit position, the first error probability being different from the second error probability;
determining, based on the second error probability, a second exponent value for the second bit position represented in the second loss function, the second exponent value being proportional to the second error probability, and being different from the first exponent value; and
updating one or more parameters of a machine-learning (ML) model of the autoencoder based on the second loss function.

13. The processing circuit of claim 12, wherein the first loss function comprises a pre-training loss function for updating the one or more parameters of the ML model of the autoencoder during one or more initial iterations of training.

14. The processing circuit of claim 12, wherein the first loss function comprises a binary cross-entropy (BCE) loss function.

15. The processing circuit of claim 11, wherein the autoencoder comprises:
an encoder configured to transmit encoded signals via a channel, the encoder comprising a first neural network; and
a decoder configured to receive and decode the encoded signals from the channel, the decoder comprising a neural network.

16. The processing circuit of claim 11, wherein the autoencoder comprises an encoder configured to transmit encoded signals via a channel, the encoder comprising a transformer encoder.

17. The processing circuit of claim 16, wherein the encoder is a last encoding stage before the channel.

18. The processing circuit of claim 11, wherein the autoencoder comprises a decoder configured to receive and decode encoded signals from a channel, the decoder comprising a transformer encoder.

19. A system comprising:
a user equipment (UE) comprising an autoencoder, wherein:
the UE is configured to transmit a first transmit signal encoded by the autoencoder; and
the autoencoder is trained to perform channel coding based on:
receiving, by an input of the autoencoder, a first bit sequence comprising a plurality of positions;
determining, based on a first error probability associated with a first bit position of the plurality of positions, a first exponent value for the first bit position represented in a loss function, the first exponent value being proportional to the first error probability; and
encoding, by the autoencoder or by a second autoencoder trained based on the first exponent value, a transmit signal.

20. The system of claim 19, wherein the UE is configured to receive and decode, by the autoencoder, a second transmit signal.
